(19) United States
(12) Patent Application Publication
(10) Pub. No.: US 2024/0274100 A1
(43) Pub. Date: Aug. 15, 2024

(54) RESOURCE CONTROL METHOD, FRAME RATE CONTROL METHOD AND CONTROLLER FOR CONTROLLING FRAME RATES IN MULTI-WINDOW SCENARIO

(71) Applicant: MEDIATEK INC., Hsinchu City (TW)

(72) Inventors: Chung-Yang CHEN, Hsinchu City (TW); Chia-Chun HSU, Hsinchu City (TW); Jei-Feng LI, Hsinchu City (TW); Yi-Hsin SHEN, Hsinchu City (TW); Guo LI, Chengdu (TW); Ta-Chang LIAO, Hsinchu City (TW); Yu-Chia CHANG, Hsinchu City (TW); Hung-Hao CHANG, Hsinchu City (TW); Po-Ting CHEN, Hsinchu City (TW); Yu-Hsien LIN, Hsinchu City (TW)

(21) Appl. No.: 18/415,812

(22) Filed: Jan. 18, 2024

Related U.S. Application Data
(60) Provisional application No. 63/484,759, filed on Feb. 14, 2023.

(30) Foreign Application Priority Data
Dec. 26, 2023 (CN) 202311826091.X

(51) Int. Cl. G09G 5/00; G09G 5/14

(52) U.S. Cl. CPC G09G 5/003; G09G 5/14; G09G 2320/041; G09G 2330/023; G09G 2340/0435; G09G 2354/00

(57) ABSTRACT

A frame rate control method is provided. A primary scenario and a non-primary scenario are identified according to two or more windows displayed on a screen. Each of the primary scenario and the non-primary scenario is performed by an individual application. A frame rate of the non-primary scenario is decreased when a performance index indicates that a first condition is present. The application corresponding to the non-primary scenario is disabled when the performance index indicates that a second condition is present after decreasing the frame rate of the non-primary scenario, so as to remove the window corresponding to the non-primary scenario from the screen.

### CROSS REFERENCE TO RELATED APPLICATIONS

This application claims the benefit of U.S. Provisional Application No. 63/484,759, filed Feb. 14, 2023, and China patent application Ser. No. 202311826091.X filed on Dec. 16, 2023, the entirety of which are incorporated by reference herein.

### BACKGROUND OF THE INVENTION

### Field of the Invention

The present invention relates to frame rate control method, and, in particular, to frame rate control method in multi-window scenario.

### Description of the Related Art

Accompanying the rapid development of electronic products and fast changes in communication technology, mobile devices such as smartphones and tablets have become indispensable. Along with the popularization of these technologies, many consumers have transferred their regular daily online activity from a PC platform to their mobile devices, such as browsing webpages, receiving and sending emails, and viewing media content.

Currently, a multi-window display technology is being used widely on mobile devices, especially foldable phones. In a multi-window scenario, a plurality of windows are displayed on the screen of said mobile device. Therefore, multi-window resource control of the mobile device is desired for a better user experience.

### BRIEF SUMMARY OF THE INVENTION

An embodiment of the present invention provides a frame rate control method. A primary scenario and a non-primary scenario are identified according to two or more windows displayed on a screen. Each of the primary scenario and the non-primary scenario is performed by an individual application. The frame rate of the non-primary scenario is decreased when the performance index indicates that the first condition is present (or met). The application corresponding to the non-primary scenario is disabled when the performance index indicates that the second condition is met after decreasing the frame rate of the non-primary scenario, so as to remove the window corresponding to the non-primary scenario from the screen.

Furthermore, an embodiment of the present invention provides a frame rate control method. A primary scenario and a non-primary scenario are identified in the multi-window scenario of a mobile device. Each of the primary scenario and the non-primary scenario is displayed in an individual window on the screen of the mobile device. The frame rate of the non-primary scenario is decreased and the frame rate of the primary scenario is kept when the performance index indicates that the first condition is present. The frame rate of the non-primary scenario is decreased to the first frame rate and the frame rate of the primary scenario is decreased to the second frame rate when the performance index indicates that the second condition is present. The first frame rate is lower than the second frame rate.

Moreover, an embodiment of the present invention provides a controller for controlling frame rates in multi-window scenario of a mobile device. A processor is configured to identify a primary scenario and a non-primary scenario according to two or more windows displayed on a screen of the mobile device. The processor is coupled to the screen. When a temperature of the mobile device is equal to or greater than a first threshold value, the processor is configured to decrease the frame rate of the non-primary scenario. When the temperature of the mobile device is higher than a second threshold value (which is, itself, higher than the first threshold value), the processor is configured to close the non-primary scenario, so as to remove the window corresponding to the non-primary scenario from the screen.

### BRIEF DESCRIPTION OF THE DRAWINGS

The present invention can be more fully understood by reading the subsequent detailed description and examples with references made to the accompanying drawings, wherein:

FIG. 1 shows a mobile device according to some embodiments of the invention.

FIG. 2 shows a frame rate control method for a multi-window scenario according to some embodiments of the invention.

FIG. 3 shows the multi-window scenario according to some embodiments of the invention.

FIG. 4 shows the multi-window scenario according to some embodiments of the invention.

FIG. 5 shows a block diagram illustrating the software architecture of the frame rate control method in the multi-window scenario according to some embodiments of the invention.

FIG. 6 shows a table illustrating the resource adjustment in multi-window scenario according to some embodiments of the invention.

FIG. 7 shows a table illustrating the resource adjustment in multi-window scenario according to some embodiments of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Some variations of the embodiments are described. Throughout the various views and illustrative embodiments, like reference numbers are used to designate like elements. It should be understood that additional operations can be provided before, during, and/or after a disclosed method, and some of the operations described can be replaced or eliminated for other embodiments of the method.

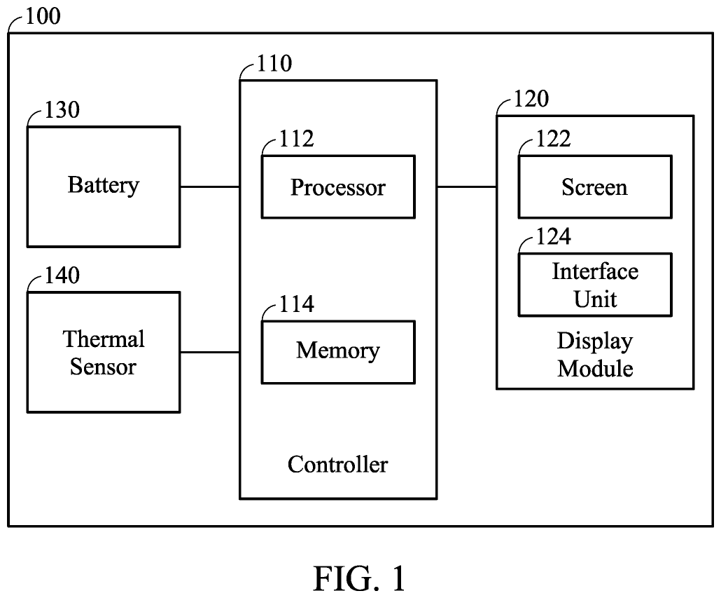

FIG. 1 shows a mobile device 100 according to some embodiments of the invention. The mobile device 100 includes a controller 110, a display module 120, a battery 130, and a thermal sensor 140. The mobile device 100 is powered by the battery 130. In order to simplify the illustration, other circuits and devices of the mobile device 100 are omitted in FIG. 1.

The controller 110 includes at least one processor 112 and at least one memory 114. The processor 112 may include one or more processing units. For example, the processor 112 may include a central processing unit (CPU), an application processor (application processor, AP), a modem processor, a graphics processing unit (graphics processing unit, GPU), an image signal processor (image signal processor, ISP), a controller, a video codec, a digital signal processor (digital signal processor, DSP), a baseband processor, and/or a neural-network processing unit (neural-network processing unit, NPU). Different processing units may be independent components, or may be integrated into one or more processors. The memory 114 is configured to store instructions and data. The memory 114 may store instructions or data that is used by the processor 112. By using the processor 112 and the memory 114, the controller 110 may be a nerve center and a command center of the mobile device 100. The controller 110 may perform the applications according to instruction operation code and a time sequence signal.

The thermal sensor 140 is configured to sense a temperature of the mobile device 100. In some embodiments, the thermal sensor 140 is an independent sensor disposed on a circuit board, and the thermal sensor 140 is located near thermal source(s) such as the controller 110, the display module 120 and/or the battery 130. In some embodiments, the thermal sensor 140 may be an on-chip thermal sensor used for sensing a junction temperature, a skin temperature, and/or a printed circuit board (pcb) temperature of the controller 110.

The display module 120 includes the screen 122 and the interface unit 124. The screen 122 is configured to display the image, video or the like according to the frame data from the controller 110. The screen 122 is implemented in a display panel. The display panel may be a liquid crystal display (LCD), an organic light-emitting diode (OLED), an active-matrix organic light-emitting diode (AMOLED), a flexible light-emitting diode (FLED), a mini-LED, a micro-LED, a micro-OLED, quantum dot light-emitting diodes (QLED), or the like. The interface unit 124 is configured to provide the user input to the controller 110. In some embodiments, the screen 122 and the interface unit 124 are implemented in a touch panel.

In a multi-window scenario, multiple windows are displayed on the screen 122. The multi-window scenario may specifically include a plurality of application scenarios, for example, a multi-application multi-window scenario, a single-application multi-window scenario, a split-screen multi-application multi-window scenario, or a picture-in-picture scenario. For example, in the multi-application multi-window scenario, multiple application windows are displayed on the screen 122, and a size and a location of each window may be arbitrary. The size and the location of the window can be modified by dragging the window by the user through the interface unit 124. In some embodiments, different windows may be displayed in a cascade manner. In some embodiments, the windows displayed on the screen 122 may occupy the entire screen 122. In some embodiments, the windows displayed on the screen 122 may only occupy a part of the screen 122.

When multiple windows are displayed on the screen 122 in the multi-window scenario, the controller 110 is capable of detecting the scenario of each window to regulate the operations of the scenarios, so as to improve user experience for the primary scenario under the limited resources of the mobile device 100.

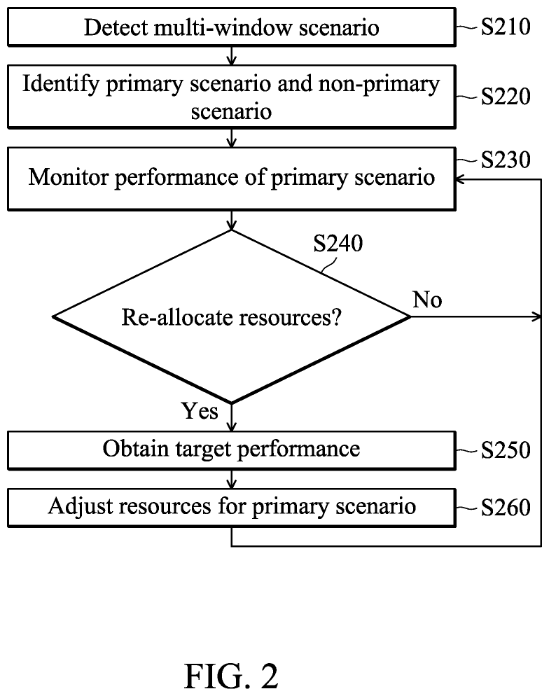

FIG. 2 shows a frame rate control method for a multi-window scenario according to some embodiments of the invention. The frame rate control method is performed by the controller 110 of FIG. 1. Frame rate is the rate at which frames of visual content are provided. Furthermore, the frame rate may be represented in Frames Per Second (FPS).

First, in step S210, according to the applications performed by the processor 112, the controller 110 is configured to detect that multi-window scenario is present, i.e., multiple windows are displayed on the screen 122. Furthermore, each window is configured to provide (or display) a scenario performed by an individual application. In other words, the processor 112 is configured to simultaneously perform the various applications for the user to play game, watch video or Live Broadcast, or use video call.

In step S220, the controller 110 is configured to identify a primary scenario and a non-primary scenario (or more non-primary scenarios) in the multi-window scenario, and the primary scenario and the non-primary scenario are provided (displayed) by different windows on the screen 122. In some embodiments, the primary scenario and the non-primary scenario are identified according to the user behavior index, and the user behavior index includes information regarding the behavior of the user operating the screen 122, e.g., the user input from the interface unit 124. In some embodiments, the user behavior index indicates which window on the screen 122 was viewed or focused. In some embodiments, the primary scenario is identified according to the user behavior index indicating which window was last touched or which window was touched the most times in a specific time. In some embodiments, the primary scenario is identified according to the user behavior index indicating which window has the longest usage time. In some embodiments, the primary scenario is identified according to the user behavior index indicating which window has the largest window size. In some embodiments, the primary scenario and the non-primary scenario are identified by AI (artificial intelligence). In some embodiments, the primary scenario and the non-primary scenario are determined by the user predetermined setting, e.g., the importance of each scene is assigned by the user.

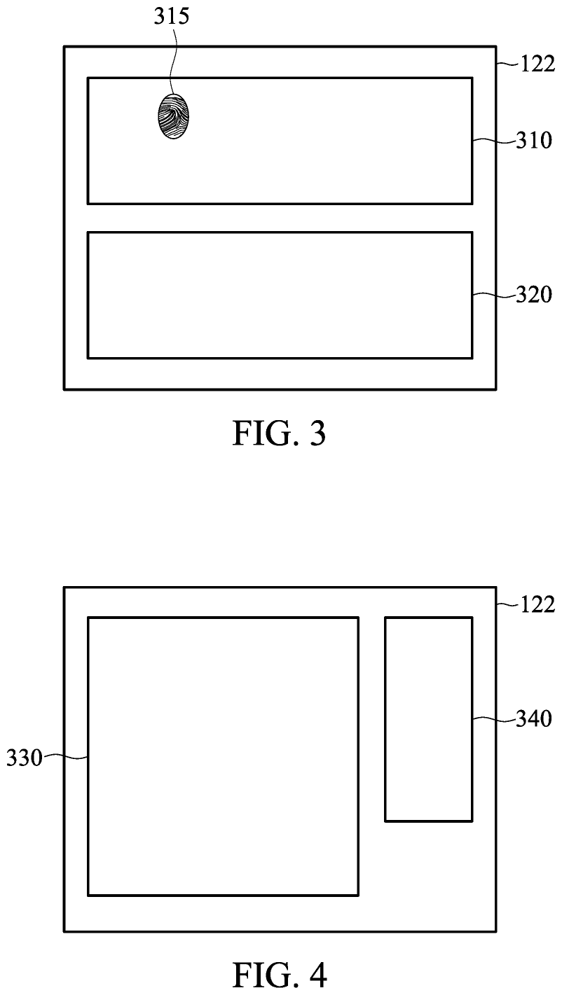

Referring to FIG. 3, FIG. 3 shows the multi-window scenario according to some embodiments of the invention. In FIG. 3, the windows 310 and 320 are displayed on the screen 122. The window 310 is configured to provide a first scenario of a first application performed by the controller 110, and the window 320 is configured to provide a second scenario of a second application performed by the controller 110. In such embodiment, the window 310 and the window 320 have the same window size. Moreover, the user behavior index includes the information of touch, window size and usage time of each of the windows 310 and 320. In some embodiments, the user behavior index is selected or assigned priority by the user.

In some embodiments, the primary scenario is identified according to the user behavior index that is selected (assigned) to indicate which window was last touched. For example, the window 310 was last touched by the user, as shown in label 315 in FIG. 3. According to the user behavior index indicating the window 310 was last touched, the controller 110 is configured to determine (or identify) that the first scenario provided by the window 310 is the primary scenario and the second scenario provided by the window 320 is the non-primary scenario.

In some embodiments, the primary scenario is identified according to the user behavior index that is selected (assigned) to indicate the window having the most touches. For example, in a specific time period (e.g., the last five minutes), the window 310 was touched 3 times, and the second window was touched 12 times, i.e., the number of touches of the window 310 is lower than the number of touches of the window 320 during the last five minutes. According to the user behavior index, the controller 110 is configured to determine (or identify) that the first scenario is the non-primary scenario since the window 310 has the least number of touches during the last five minutes, and the second scenario is the non-primary scenario since the window 320 has the most touches during the last five minutes.

In some embodiments, the primary scenario is identified according to the user behavior index that is selected (assigned) to indicate the window focused by the user. For example, the user behavior index indicates which one of the windows 310 and 320 is viewed by the user, which audio has been played in the window 310 or 320 through a speaker of the mobile device 100 or which one of the windows 310 and 320 has larger sound level.

Referring to FIG. 4, FIG. 4 shows the multi-window scenario according to some embodiments of the invention. In FIG. 4, the windows 330 and 340 are displayed on the screen 122. The window 330 is configured to provide a third scenario of a third application performed by the controller 110, and the window 340 is configured to provide a fourth scenario of a fourth application performed by the controller 110. In such embodiment, the window 330 and the window 340 have the different window sizes.

In FIG. 4, the primary scenario is identified according to the user behavior index that is selected (assigned) to indicate the large window. For example, window 330 is larger than window 340. Therefore, the controller 110 is configured to determine (or identify) that the third scenario is the primary scenario because the window 330 is large, and the fourth scenario is the non-primary scenario because the window 340 is small. It should be noted that although the primary scenario and the non-primary scenario are described as being identified according to two windows, the primary scenario and the non-primary scenario may be identified according to more than two windows.

Referring back to step S230 of FIG. 2, after the primary scenario is identified, the controller 110 is configured to monitor performance of the primary scenario and the mobile device 100 to obtain a performance index. The performance index includes the information regarding the frame rate of the primary scenario that is the frequency (rate) at which consecutive images (frames) are displayed in the corresponding window on the screen 122. The performance index further includes the information regarding the component state of the mobile device 100. In some embodiments, the component state includes the remaining battery power of the battery 130 and/or the temperature sensed by the thermal sensor 140.

In step S240, according to the performance index, the controller 110 is configured to determine whether to re-allocate resource for maintaining or optimizing the performance of the primary scenario. If there is no need to re-allocate resources (i.e., no frame dropping or frame jitter and the remaining battery power and the sensed temperature are normal), the flowchart is returned to step S230, and the performance of the primary scenario is monitored again. If resources need to be re-allocated, the controller 110 is configured to obtain (or calculate) the target performance (e.g., the target frame rate) of the primary scenario (step S250).

In step S260, the controller 110 is configured to adjust the resources of the mobile device 100 for the primary scenario, and then the flowchart is returned to step S230. Thus, the performance of the primary scenario is monitored again after adjusting the resources of the mobile device 100.

In some embodiments, when the performance index indicates that the frame dropping or frame jitter is present in the primary scenario (step S240), the controller 110 is configured to reduce the resource of the non-primary scenario (step S260) so as to preserve the frame rate of the primary scenario or improve the performance of the primary scenario (e.g., the target performance obtained in step S250). In some embodiments, reducing the resource of the non-primary scenario includes decreasing the frame rate of the non-primary scenario, assigning Android package (APK) to certain CPU, or decreasing the resolution of the non-primary scenario. In general, the frame dropping (e.g., some frames may be dropped before reaching the display module 120) or the frame jitter (e.g., the frame rate is unstable) is caused by the overloaded processor 112. The frame dropping or the frame jitter often causes graphics contents to stutter and pause on the screen, which can negatively impact the user experience. In some embodiments, after the resource (such as the frame rate or the resolution) of the non-primary scenario is decreased and the frame dropping or frame jitter is still present in the primary scenario, the controller 110 is configured to disable the non-primary scenario (i.e., only the window corresponding to the primary scenario is displayed on the screen 122), so as to preserve the frame rate of the primary scenario or improve the performance of the primary scenario.

In some embodiments, when the performance index indicates that the component state is bad (step S240), the controller 110 is configured to reduce the resource of the non-primary scenario (step S260) so as to preserve the frame rate of the primary scenario or improve the performance of the primary scenario (e.g., the target performance obtained in step S250). In some embodiments, reducing the resource of the non-primary scenario includes decreasing the frame rate of the non-primary scenario, assigning Android package (APK) to certain CPU, or decreasing the resolution of the non-primary scenario. The component state is deemed to be bad when certain conditions are met, such as when the remaining battery power of the battery 130 is lower than the battery threshold value, or when the temperature sensed by the thermal sensor 140 is higher than the thermal threshold value of the mobile device 100. In some embodiments, if the component state is still bad after the resource (such as the frame rate or the resolution) of the non-primary scenario is decreased, the controller 110 is configured to disable the non-primary scenario (i.e., only the window corresponding to the primary scenario is displayed on the screen 122), so as to preserve the frame rate of the primary scenario or improve the performance of the primary scenario.

In some embodiments, the resource of the non-primary scenario may be decreased (steps S250, S260) directly after step S220. That is, the resource of the non-primary scenario is decreased without further determination (e.g. steps S230, S240 are skipped) after the primary scenario and non-primary scenario are identified (step S220).

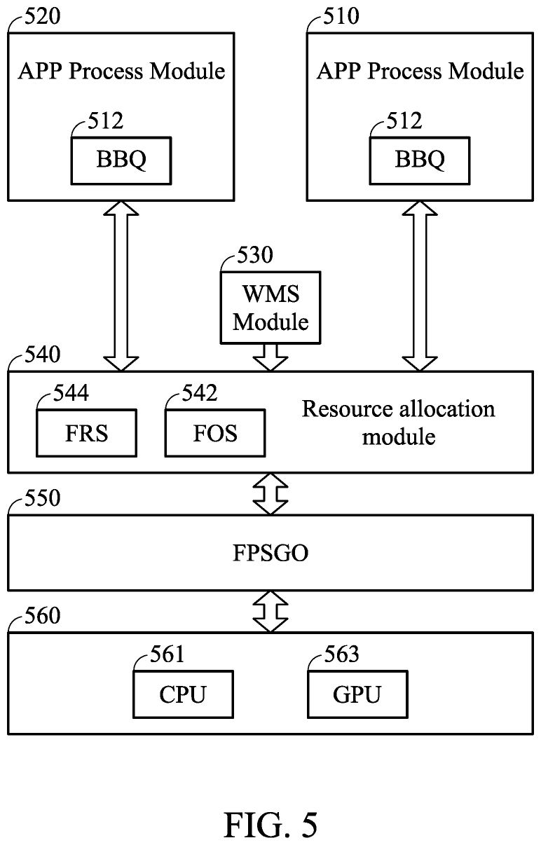

FIG. 5 shows a block diagram illustrating the software architecture of the frame rate control method in the multi-window scenario according to some embodiments of the invention. The software architecture includes the application (APP) process modules 510 and 520, the window management system (WMS) module 530, the resource allocation module 540, the frame rate monitor/system capability control (FPSGO) module 550 and the main process module 560. Each module may be a software module implemented with program code and executed by the processor 112 to collaborate with each other for performing dynamic frame rate adjustment.

The APP process module 510 is configured to perform a first application for display a first scenario in a first window on the screen 122. The APP process module 510 includes a blast buffer queue (BBQ) 512, and the frames of the first scenario are displayed based on the BBQ 512 and related settings. The APP process module 520 is configured to perform a second application for displaying a second scenario in a second window on the screen 122. The APP process module 520 includes a BBQ 522, and the frames of the second scenario are displayed based on the BBQ 522 and related settings.

The WMS module 530 is configured to notify window priority of the first and second windows on the screen 122. Furthermore, the WMS module 530 is further configured to provide the foreground applications list that recording the first application corresponding to the first scenario and the second application corresponding to the second scenario. In some embodiments, the user behavior index is provided by the WMS module 530.

The resource allocation module 540 includes the frame rate operation service (FOS) 542 and the frame rate smoother (FRS) 544. The FOS 542 is configured to detect whether multi-window scenario is present and to identify the primary scenario and the non-primary scenario in the multi-window scenario according to the information from the WMS module 530.

The FRS 544 is configured to obtain the performance index with the information regarding the frame rate of each scenario and the component state of the mobile device 100. In response to the performance index and the default frame rates of the various scenarios, the FRS 544 is configured to determine whether to re-allocate resources for the primary scenario in multi-window scenario. In some embodiments, the FRS 544 is configured to adjust the resources of the mobile device 100 to meet the target performance (e.g., the target frame rate) of the first and second scenarios. Furthermore, the resource allocation module 540 is further configured to provide the target performance to the FPSGO 550.

The FPSGO 550 is configured to provide the new frame rates and related settings corresponding to the target performance to the resource allocation module 540. In response to the new frame rates and related settings, the resource allocation module 540 is configured to provide the frame rate controlling settings to the APP process modules 510 and 520 for the first and second scenarios. Furthermore, FPSGO 550 is further configured to provide the new frame rates and related settings corresponding to the target performance to the main process module 560, so that the tasks performed in the CPU 561 and/or GPU 563 can be adjusted accordingly.

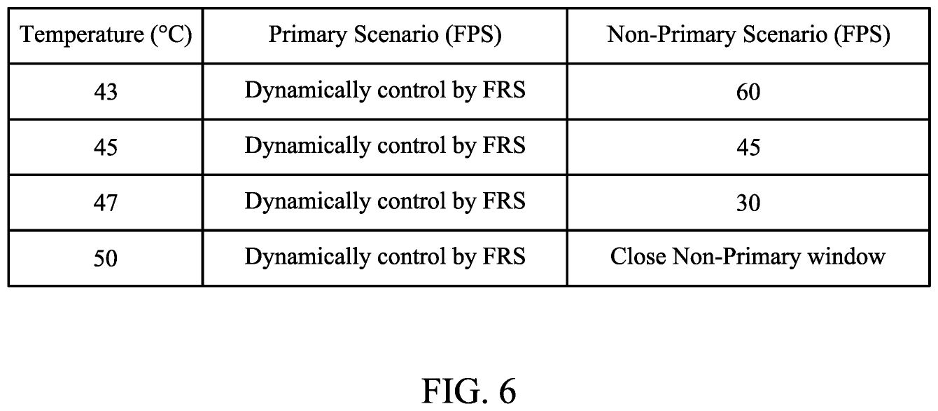

FIG. 6 shows a table illustrating the resource adjustment in multi-window scenario according to some embodiments of the invention. In FIG. 6, it is assumed that the resource (e.g., the frame date) is adjusted when the performance index indicates that the temperature sensed by the thermal sensor 140 is abnormal, e.g., the temperature of the mobile device 100 is too high. It should be noted that the relationship between the frame rate and the sensed temperature are used as an example, and not to limit the invention.

In the embodiment of FIG. 6, the default frame rates of the primary scenario displayed in the primary window and the non-primary scenario displayed in the non-primary window are 120 FPS. When the performance index indicates that the sensed temperature is higher than or equal to 43° C., the resource allocation module 540 is configured to decrease the frame rate of the non-primary scenario from 120 FPS to 60 FPS, i.e., the frame rate of the non-primary scenario in decreased to half. Simultaneously, the frame rate of the primary scenario is dynamically controlled by the FRS 544 of the resource allocation module 540, such as the frame rate of the primary scenario may be kept at the default frame rate or decreased to 80% of the default frame rate. In some embodiments, when the sensed temperature drops below 43° C. after decreasing the frame rate of the non-primary scenario to 60 FPS, the default frame rate of the non-primary scenario will be restored.

When the performance index indicates that the sensed temperature is higher than or equal to 45° C. after decreasing the frame rate of the non-primary scenario to 60 FPS, the resource allocation module 540 is configured to decrease the frame rate of the non-primary scenario from 60 FPS to 45 FPS. Simultaneously, the frame rate of the primary scenario is dynamically controlled by the FRS 544 of the resource allocation module 540, such as the frame rate of the primary scenario may be kept at the default frame rate or decreased to 80% of the default frame rate. In some embodiments, when the sensed temperature drops below 45° C. after decreasing the frame rate of the non-primary scenario to 45 FPS, the frame rate of the non-primary scenario is increased to 60 FPS.

When the performance index indicates that the sensed temperature is higher than or equal to 47° C. after decreasing the frame rate of the non-primary scenario to 45 FPS, the resource allocation module 540 is configured to decrease the frame rate of the non-primary scenario from 45 FPS to 30 FPS. Simultaneously, the frame rate of the primary scenario is dynamically controlled by the FRS 544 of the resource allocation module 540, such as the frame rate of the primary scenario may be kept at the default frame rate or decreased to 80% of the default frame rate. In some embodiments, when the sensed temperature drops below 47° C. after decreasing the frame rate of the non-primary scenario to 30 FPS, the frame rate of the non-primary scenario is increased to 45 FPS.

When the performance index indicates that the sensed temperature is higher than or equal to 50° C. after decreasing the frame rate of the non-primary scenario to 30 FPS, the resource allocation module 540 is configured to close (or remove) the non-primary window, i.e., the non-primary scenario is disabled. Simultaneously, the frame rate of the primary scenario is dynamically controlled by the FRS 544 of the resource allocation module 540, such as the frame rate of the primary scenario may be kept at the default frame rate or decreased to 80% of the default frame rate. In other words, the controller 110 is configured to stop performing the application of the non-primary scenario (i.e., the multi-window scenario is absent), so as to reserve resources for the primary scenario.

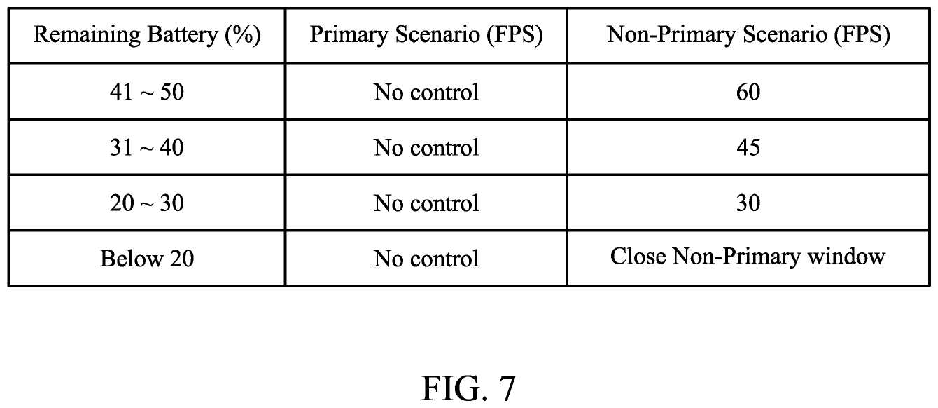

FIG. 7 shows a table illustrating the resource adjustment in multi-window scenario according to some embodiments of the invention. In FIG. 7, it is assumed that the resource (e.g., the frame date) is adjusted when the performance index indicates that the remaining battery power of the battery 130 is decreased. In some embodiments, the frame rate of the primary scenario will not be adjusted by the resource allocation module 540. In some embodiments, the frame rate of the primary scenario is kept by the resource allocation module 540. Furthermore, the relationship between the frame rate and the remaining battery power are used as an example, and not to limit the invention.

In the embodiment of FIG. 7, the default frame rates of the primary scenario displayed in the primary window and the non-primary scenario displayed in the non-primary window are 120 FPS. When the performance index indicates that the remaining battery power of the battery 130 is between 41% and 50%, the resource allocation module 540 is configured to decrease the frame rate of the non-primary scenario from 120 FPS to 60 FPS, i.e., the frame rate of the non-primary scenario in decreased to half. In some embodiments, when the battery 130 is charged and the remaining battery power of the battery 130 is higher than 50% after decreasing the frame rate of the non-primary scenario to 60 FPS, the default frame rate of the non-primary scenario will be restored.

When the performance index indicates that the remaining battery power of the battery 130 is between 31% and 40% after decreasing the frame rate of the non-primary scenario to 60 FPS, the resource allocation module 540 is configured to decrease the frame rate of the non-primary scenario from 60 FPS to 45 FPS. In some embodiments, when the battery 130 is charged and the remaining battery power of the battery 130 is higher than 40% after decreasing the frame rate of the non-primary scenario to 45 FPS, the frame rate of the non-primary scenario is increased to 60 FPS.

When the performance index indicates that the remaining battery power of the battery 130 is between 20% and 30% after decreasing the frame rate of the non-primary scenario to 45 FPS, the resource allocation module 540 is configured to decrease the frame rate of the non-primary scenario from 45 FPS to 30 FPS. In some embodiments, when the battery 130 is charged and the remaining battery power of the battery 130 is higher than 30% after decreasing the frame rate of the non-primary scenario to 30 FPS, the frame rate of the non-primary scenario is increased to 45 FPS.

When the performance index indicates that the remaining battery power of the battery 130 is lower than 20% after decreasing the frame rate of the non-primary scenario to 30 FPS, the resource allocation module 540 is configured to close (remove) the non-primary window, i.e., the non-primary scenario is disabled. In other words, the controller 110 is configured to stop performing the application of the non-primary scenario (i.e., the multi-window scenario is absent), so as to reserve resources for the primary scenario.

Embodiments for controlling frame rates in multi-window scenario of the mobile device 100 are provided. The primary scenario is identified from the windows on the screen 122. The performance of the primary scenario and the operating status of the mobile device 100 are monitored, so as to dynamically adjust resources for the primary scenario. Compared with the conventional multi-window scenario that cannot adjust the frame rate of each scenario, the frame rate of non-primary scenario is dynamically decreased to provide the resource for the primary scenario in the mobile device 100, so as to obtain higher average and standard deviation of the frame rate in the primary scenario, thereby optimizing the user experience. Furthermore, the power consumption of the mobile device 100 is also decreased due to the decreased frame rate of the non-primary scenario or the disabled non-primary scenario.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A resource control method, comprising:
identifying a primary scenario and a non-primary scenario according to two or more windows displayed on a screen; and
reducing a resource of the non-primary scenario.

2. The resource control method as claimed in claim 1, wherein identifying the primary scenario and the non-primary scenario according to the two or more windows displayed on the screen further comprises:
detecting user input on the two or more windows of the screen to obtain a user behavior index,
wherein the user behavior index comprises the number of touches of the two or more windows and usage time of the two or more windows,
wherein the primary scenario is displayed in the window with the most touches or the longest usage time, and the non-primary scenario is displayed in the window with the least number of touches or the shortest usage time.

3. The resource control method as claimed in claim 1, wherein identifying the primary scenario and the non-primary scenario according to the two or more windows displayed on the screen further comprises:
detecting window sizes of the two or more windows on the screen,
wherein the primary scenario is displayed in the window having a large window size, and the non-primary scenario is displayed in the window having a small window size.

4. The resource control method as claimed in claim 1, wherein decreasing the resource of the non-primary scenario comprises: decreasing a frame rate of the non-primary scenario, assigning an Android package (APK) to certain central processing unit, or decreasing the resolution of the non-primary scenario.

5. The resource control method as claimed in claim 4, wherein each of the primary scenario and the non-primary scenario is performed by an individual application,
wherein the method further comprises:
decreasing the frame rate of the non-primary scenario when a performance index indicates that a first condition is present.

6. The resource control method as claimed in claim 5, further comprising:
disabling the application corresponding to the non-primary scenario when the performance index indicates that a second condition is present after decreasing the frame rate of the non-primary scenario, so as to remove the window corresponding to the non-primary scenario from the screen.

7. The resource control method as claimed in claim 5, wherein decreasing the frame rate of the non-primary scenario when the performance index indicates that the first condition is present further comprises:
detecting a battery to obtain remaining battery power or sensing a temperature; and
decreasing the frame rate of the non-primary scenario when the remaining battery power is equal to or less than a first threshold value, the temperature is equal to or higher than a first threshold value, or frame dropping or frame jitter of the primary scenario is present.

8. The resource control method as claimed in claim 7, wherein disabling the application corresponding to the non-primary scenario when the performance index indicates the second condition is present after decreasing the frame rate of the non-primary scenario further comprises:
continuously decreasing the frame rate of the non-primary scenario when the remaining battery power is lower than the first threshold value and higher than a second threshold value; and
disabling the application corresponding to the non-primary scenario when the remaining battery power is lower than the second threshold value.

9. The resource control method as claimed in claim 7, wherein disabling the application corresponding to the non-primary scenario when the performance index indicates the second condition is present after decreasing the frame rate of the non-primary scenario further comprises:
continuously decreasing the frame rate of the non-primary scenario when the temperature is higher than the first threshold value and lower than a second threshold value; and
disabling the application corresponding to the non-primary scenario when the temperature is higher than the second threshold value.

10. The resource method as claimed in claim 4, wherein decreasing the frame rate of the non-primary scenario when the performance index indicates that the first condition is present further comprises:
decreasing the frame rate of the non-primary scenario from a default frame rate to a first frame rate when the performance index indicates that the first condition is present; and
decreasing a frame rate of the primary scenario from the default frame rate to a second frame rate when the performance index indicates that the first condition is present,
wherein the second frame rate is higher than the first frame rate.

11. A frame rate control method, comprising:
identifying a primary scenario and a non-primary scenario in a multi-window scenario of a mobile device, wherein each of the primary scenario and the non-primary scenario is displayed in an individual window on a screen of the mobile device;
decreasing a frame rate of the non-primary scenario and preserving a frame rate of the primary scenario when a performance index indicates that a first condition is present; and
decreasing the frame rate of the non-primary scenario to a first frame rate and decreasing the frame rate of the primary scenario to a second frame rate when the performance index indicates that a second condition is present,
wherein the first frame rate is lower than the second frame rate.

12. The frame rate control method as claimed in claim 11, wherein identifying the primary scenario and the non-primary scenario in the multi-window scenario of the mobile device further comprises:
detecting user input on the windows of the screen to obtain a user behavior index,
wherein the user behavior index comprises the number of touches of the windows and usage time of the windows,
wherein the primary scenario is displayed in the window with the most touches or the longest usage time, and the non-primary scenario is displayed in the window with the least number of touches or the shortest usage time.

13. The frame rate control method as claimed in claim 11, wherein identifying the primary scenario and the non-primary scenario in the multi-window scenario of the mobile device further comprises:
detecting window sizes of the windows,
wherein the primary scenario is displayed in the window with a large window size, and the non-primary scenario is displayed in the window with a small window size.

14. The frame rate control method as claimed in claim 11, wherein decreasing the frame rate of the non-primary scenario and preserving the frame rate of the primary scenario when the performance index indicates that the first condition is present further comprises:
detecting a battery of the mobile device to obtain remaining battery power; and
decreasing the frame rate of the non-primary scenario and preserving the frame rate of the primary scenario when the remaining battery power is equal to or less than a first threshold value.

15. The frame rate control method as claimed in claim 11, wherein decreasing the frame rate of the non-primary scenario to the first frame rate and decreasing the frame rate of the primary scenario to the second frame rate when the performance index indicates that the second condition is present further comprises:
sensing a temperature; and
decreasing the frame rate of the non-primary scenario to the first frame rate and decreasing the frame rate of the primary scenario to the second frame rate when the temperature is equal to or higher than a first threshold value.

16. The frame rate control method as claimed in claim 11, further comprising:
removing the window corresponding to the non-primary scenario from the screen when the performance index indicates that a third condition is present after decreasing the frame rate of the non-primary scenario.

17. The frame rate control method as claimed in claim 16, wherein removing the window corresponding to the non-primary scenario from the screen when the performance index indicates that the third condition is present after decreasing the frame rate of the non-primary scenario further comprises:
continuously decreasing the frame rate of the non-primary scenario when the remaining battery power is lower than a first threshold value and higher than a second threshold value; and
removing the window corresponding to the non-primary scenario from the screen when the remaining battery power is lower than the second threshold value.

18. The frame rate control method as claimed in claim 16, wherein removing the window corresponding to the non-primary scenario from the screen when the performance index indicates that the third condition is present after decreasing the frame rate of the non-primary scenario further comprises:
continuously decreasing the frame rate of the non-primary scenario to lower than the first frame rate when the temperature is higher than a first threshold value and lower than a second threshold value; and
removing the window corresponding to the non-primary scenario from the screen when the temperature is higher than the second threshold value.

19. The frame rate control method as claimed in claim 11, further comprising:
decreasing the frame rate of the non-primary scenario when frame dropping or frame jitter of the primary scenario is present.

20. A controller for controlling resource in multi-window scenario of a mobile device, comprising:
a processor configured to:
identify a primary scenario and a non-primary scenario according to two or more windows displayed on a screen of the mobile device, and
reducing a resource of the non-primary scenario;
wherein decreasing the resource of the non-primary scenario comprises:
decreasing a frame rate of the non-primary scenario, assigning an Android package (APK) to certain central processing unit, or decreasing the resolution of the non-primary scenario;
wherein when a temperature of the mobile device is equal to or higher than a first threshold value or remaining battery power of a battery of the mobile device is lower than a second threshold value, the processor is configured to decrease the resource of the non-primary scenario;
wherein when the temperature of the mobile device is higher than a third threshold value that is higher than the first threshold value, or the remaining battery power of the battery is lower than a fourth threshold value that is lower than the second threshold value, the processor is configured to close the non-primary scenario, so as to remove the window corresponding to the non-primary scenario from the screen.
